(19) United States
(12) Patent Application Publication
(10) Pub. No.: US 2014/0022360 A1
(43) Pub. Date: Jan. 23, 2014

(54) IMAGE DISPLAY SYSTEM AND LUMINANCE CONTROL METHOD

(71) Applicant: Seiko Epson Corporation, Tokyo (JP)

(72) Inventor: Hiroaki YANAI, Matsumoto-shi (JP)

(21) Appl. No.: 13/916,113

(22) Filed: Jun. 12, 2013

(30) Foreign Application Priority Data
Jul. 18, 2012 (JP) 2012-159825

(51) Int. Cl. H04N 13/04; H04N 13/00

(52) U.S. Cl. CPC H04N 13/0438; H04N 13/0007
USPC 348/55

(57) ABSTRACT

An image display system includes a display device adapted to display an image, and a pair of glasses having transmitting state switching devices capable of switching between a transmitting state in which a light adapted to form the image is transmitted and a blocking state in which the light is blocked, and either one of the display device and the pair of glasses includes a transmitting period control device adapted to control a length of a transmitting period in which the transmitting state switching devices are in the transmitting state in a display period in which the image of one frame is displayed in the display device.

### BACKGROUND

1. Technical Field

The present invention relates to an image display system and a luminance control method, and in particular to an image display system equipped with a display device for displaying an image and a pair of glasses worn by the observer, and a luminance control method to be performed in the image display system.

2. Related Art

In the past, there has been known an image display system with which a three-dimensional image can visually be recognized by individually observing a right-eye image and a left-eye image displayed in the image display system with the right eye and the left eye, respectively. As a configuration of such an image display system, there can be cited as an example a configuration provided with a display device for displaying the right-eye image and the left-eye image, and a pair of glasses having an image separation section for making the right-eye image and the left-eye image individually enter the right eye and the left eye, respectively. Further, as one of observation systems of the three-dimensional image using such an image display system, there has been known an image display system in which a time-sharing system is adopted (see, e.g., JP-A-2012-028963 (Document 1)).

In the image display system described in Document 1, the display device alternately displays the right-eye image and the left-eye image. Incidentally, among the liquid crystal shutters provided to the pair of glasses, the liquid crystal shutter provided corresponding to the right eye of the observer is set to a transmitting state when the right-eye image is displayed, and is set to a blocking state when the left-eye image is displayed. Further, the liquid crystal shutter provided corresponding to the left eye of the observer is set to the transmitting state when the left-eye image is displayed, and is set to the blocking state when the right-eye image is displayed. Thus, the observer can individually observe the right-eye image and the left-eye image respectively with the right eye and the left eye, and thus, the three-dimensional image described above is visually recognized.

Incidentally, in order to improve the image quality such as contrast, there is requested a configuration capable of controlling the luminance of the image to be observed. To cope therewith, in the image display device described in Document 1 mentioned above, the intensity of light entering a light modulation device is reduced.

However, in the case in which a discharge lamp is adopted as a light source device for emitting the light, it is difficult to instantaneously perform the light intensity control. Further, it is possible to adopt a configuration of disposing a shield plate for reducing the intensity of the light entering the light modulation device on a light path of the light entering the light modulation device. However, in such a case, it is necessary to provide a constituent for moving the shield plate according to needs, and thus, the configuration of the display device becomes complicated.

Therefore, a novel configuration capable of controlling the luminance of an image to be observed has been demanded.

### SUMMARY

An advantage of some aspects of the invention is to provide an image display system and a luminance control method capable of controlling the luminance of an image to be observed.

An image display system according to a first aspect of the invention includes a display device adapted to display an image, and a pair of glasses having a transmitting state switching device capable of switching between a transmitting state in which a light adapted to form the image is transmitted and a blocking state in which the light is blocked, and one of the display device and the pair of glasses includes a transmitting period control device adapted to control a length of a transmitting period in which the transmitting state switching device is in the transmitting state in a display period in which the image of one frame is displayed in the display device.

It should be noted that the display period in which the image of one frame is displayed denotes a period from when the display of an image of a certain frame is started to when the display of an image of a subsequent frame is started.

Here, the luminance of the image observed by the observer is the integrated value in the period in which the image can be observed via the transmitting state switching device. Therefore, the longer the period of observing the image is, the more brightly the image of one frame is observed, and the shorter the period is, the more darkly the image is observed.

Therefore, by the transmitting period control device controlling the transmitting period in which the transmitting state switching device is in the transmitting state, the period of observing the image can be controlled to thereby control the luminance of the image observed through the transmitting state switching device.

In the first aspect described above, it is preferable that a plurality of sub-frames corresponding to the image is sequentially displayed in the display period of the image of the one frame, and the transmitting period control device sets a start timing of the transmitting period to a point on and after a time point at which display of first one of the sub-frames is completed in the display period.

Here, if the transmitting state switching device is switched from the blocking state to the transmitting state before the formation of the sub-frame to be displayed first in the display period of the image of the one frame is completed, a part of the sub-frame to be newly formed is observed in an area where the image formation is performed earlier in the display device, and a part of the sub-frame having previously been formed is observed in an area where the image formation is performed later.

In particular, in the case of the configuration in which a first image and a second image different from each other are alternately displayed, a transmitting state switching device for transmitting only the first image is set to the transmitting state when displaying the first image, and a transmitting state switching device for transmitting only the second image is set to the transmitting state when displaying the second image, a part of the first image and a part of the second image are observed simultaneously.

In contrast, at the time point at which the display of the first sub-frame is completed, switching from the frame having previously been displayed to the sub-frame of the newly displayed frame is completed. Therefore, by setting the start timing of the transmitting period to a point on and after the time point at which the display of the first sub-frame is completed, only the newly displayed frame can surely be observed.

In the first aspect described above, it is preferable that the display device includes a grayscale control device adapted to one of increase and decrease a grayscale of at least one of the sub-frames from a grayscale of another of the sub-frames.

Here, as described above, the luminance of the image observed is the integrated value in the period in which the image can be observed via the transmitting state switching device. Therefore, by controlling the grayscale of the sub-frame formed within the transmitting period in which the transmitting state switching device is in the transmitting state, the luminance of the image to be observed can also be controlled.

Therefore, according to the configuration described above, by controlling the grayscale of the sub-frame to be formed in addition to the switching between the transmitting state and the blocking state in the transmitting state switching device, finer luminance control can be performed.

In the first aspect described above, it is preferable that the transmitting period control device sets a start timing of the transmitting period between a time point at which display of the first one of the sub-frames is completed in the display period and a time point at which display of a second one of the sub-frames is started, and an end timing of the transmitting period between a time point at which display of a last one of the sub-frames is completed and a time point at which display of a first one of a plurality of sub-frames constituting a subsequent frame is started, and the grayscale control device makes the gray scale of the first one of the sub-frames and the grayscale of the last one of the sub-frames equal to each other.

Here, as described above, since the luminance of the image to be observed is the integrated value in the period in which the image can be observed, in the case of setting the start timing and the end timing of the transmitting period as described above, if the grayscale is different between the first sub-frame and the last sub-frame, the luminance variation occurs in the image to be observed.

For example, in the case of assuming that four sub-frames are formed in the display period of one frame, if the start timing and the end timing of the transmitting period are set as described above, the entire second sub-frame formed and the entire third sub-framed formed are observed for the same period of time. However, since the start timing of the transmitting period is set to a time point after the formation of the first sub-frame is completed, the entire first sub-frame fails to be observed for the same period of time, and the observation time of the area in which the image is formed earlier is short compared to the observation time of the area in which the image is formed later. In contrast, since the end timing of the transmitting period is set to a time point after the formation of the last sub-frame is completed, the entire last sub-frame similarly fails to be observed for the same period of time, and the observation time of the area in which the image is formed later is short compared to the observation time of the area in which the image is formed earlier.

Therefore, if there is a difference in grayscale (luminance) between the first sub-frame and the last sub-frame, the luminance integrated in the transmitting period is different between the area in which the image is formed earlier and the area in which the image is formed later, and thus, the luminance variation occurs.

In contrast, by forming the first sub-frame and the last sub-frame to be the sub-frames with the same grayscale in the case in which the start timing and the end timing of the transmitting period are set as described above, the luminance variation described above can be inhibited from occurring.

In the first aspect described above, it is preferable that the transmitting period control device controls the length of the transmitting period frame by frame.

According to the configuration described above, since the transmitting period can be controlled frame by frame, in the case of, for example, observing an image such as a movie, the luminance control of the image can be performed by scene. Further, in the case in which the display device alternately displays a first image and a second image different from each other, it is also possible to make the luminance of the first image to be observed and the luminance of the second image to be observed different from each other. Further, in the case in which the right-eye image and the left-eye image are alternately displayed, it is possible to easily match the luminance of the respective images with each other.

In the first aspect described above, it is preferable that the transmitting state switching device is configured to be able to control a light transmittance of the transmitting state switching device, and the pair of glasses include a transmittance control device adapted to control the light transmittance of the transmitting state switching device.

According to the configuration described above, the luminance of the image to be input to the eyes of the observer in the transmitting period can more finely be controlled, and further, the luminance control can be performed for each of the observers who wear the glasses.

Further, in the case in which the light transmittance of the transmitting state switching device can be controlled in the pair of glasses, there is no need to transmit the information representing the light transmittance from the display device. According to this configuration, the configuration and the process of the display device and the pair of glasses can be simplified. Further, even in the case in which the luminance control using the light transmittance control is performed in each pair of glasses, the signals (the signals for giving notice of the switching timing to the transmitting state and notice of the switching timing to the blocking state) transmitted from the display device to each pair of glasses can be standardized. Therefore, even in the case of performing the luminance control for each of the observers, it is possible to operate the pairs of glasses in sync with each other in a reliable manner.

In the first aspect described above, it is preferable that the pair of glasses include a liquid crystal shutter as the transmitting state switching device.

According to the configuration described above, the switching between the transmitting state and the blocking state of the transmitting state switching device can be performed with relative promptness using the liquid crystal shutter. Therefore, it is possible to make it easy to control the luminance of the image to be observed to a desired luminance.

A luminance control method according to a second aspect of the invention is a luminance control method performed using an image display system having a display device adapted to display an image, and a pair of glasses configured to be able to switch between a transmitting state in which a light adapted to form the image is transmitted and a blocking state in which the light is blocked, and adapted to control luminance of the image transmitted through the pair of glasses, including the step of controlling a length of a transmitting period, in which a transmitting state switching device provided to the pair of glasses and capable of switching between the transmitting state of transmitting the light forming the image and the blocking state of blocking the light is in the transmitting state, in a display period in which the image of one frame is displayed in the display device.

According to such a luminance control method as described above, substantially the same advantages as those of the image display system described above can be obtained.

### BRIEF DESCRIPTION OF THE DRAWINGS

The invention will be described with reference to the accompanying drawings, wherein like numbers reference like elements.

FIG. 1 is a schematic diagram showing a configuration of an image display system according to a first embodiment of the invention.

FIG. 2 is a block diagram showing a configuration of a projector and a pair of glasses according to the first embodiment.

FIG. 3 is a schematic diagram for explaining a method of driving a liquid crystal panel in the first embodiment.

FIG. 4 is a diagram showing an example of a relationship between an image formation period by the liquid crystal panel and the state of each of control sections when displaying a two-dimensional image in the first embodiment.

FIG. 5 is a diagram showing an example of a relationship between the image formation period by the liquid crystal panel and the state of each of the control sections when displaying a three-dimensional image in the first embodiment.

FIG. 6 is a diagram showing an example of the relationship between the image formation period by the liquid crystal panel and the state of each of the control sections when displaying a three-dimensional image in the first embodiment.

FIG. 7 is a block diagram showing a configuration of an image display system according to a second embodiment of the invention.

FIG. 8 is a diagram showing an example of a relationship between the image formation period by the liquid crystal panel and the state of each of the control sections when displaying a three-dimensional image in the second embodiment.

FIG. 9 is a block diagram showing a configuration of an image display system according to a third embodiment of the invention.

FIG. 10 is a diagram showing an example of a relationship between the image formation period by the liquid crystal panel and the state of each of the control sections when displaying a three-dimensional image in the third embodiment.

FIG. 11 is a diagram showing an example of the relationship between the image formation period by the liquid crystal panel and the state of each of the control sections when displaying a three-dimensional image in the third embodiment.

FIG. 12 is a diagram showing an example of the relationship between the image formation period by the liquid crystal panel and the state of each of the control sections when displaying a three-dimensional image in the third embodiment.

FIG. 13 is a diagram showing an example of the relationship between the image formation period by the liquid crystal panel and the state of each of the control sections when displaying a three-dimensional image in the third embodiment.

FIG. 14 is a diagram showing an example of a relationship between an image formation period by the liquid crystal panel and the state of each of control sections when displaying a two-dimensional image in a modification of the embodiments.

### DESCRIPTION OF EXEMPLARY EMBODIMENTS

### First Embodiment

A first embodiment of the invention will hereinafter be explained with reference to the accompanying drawings.

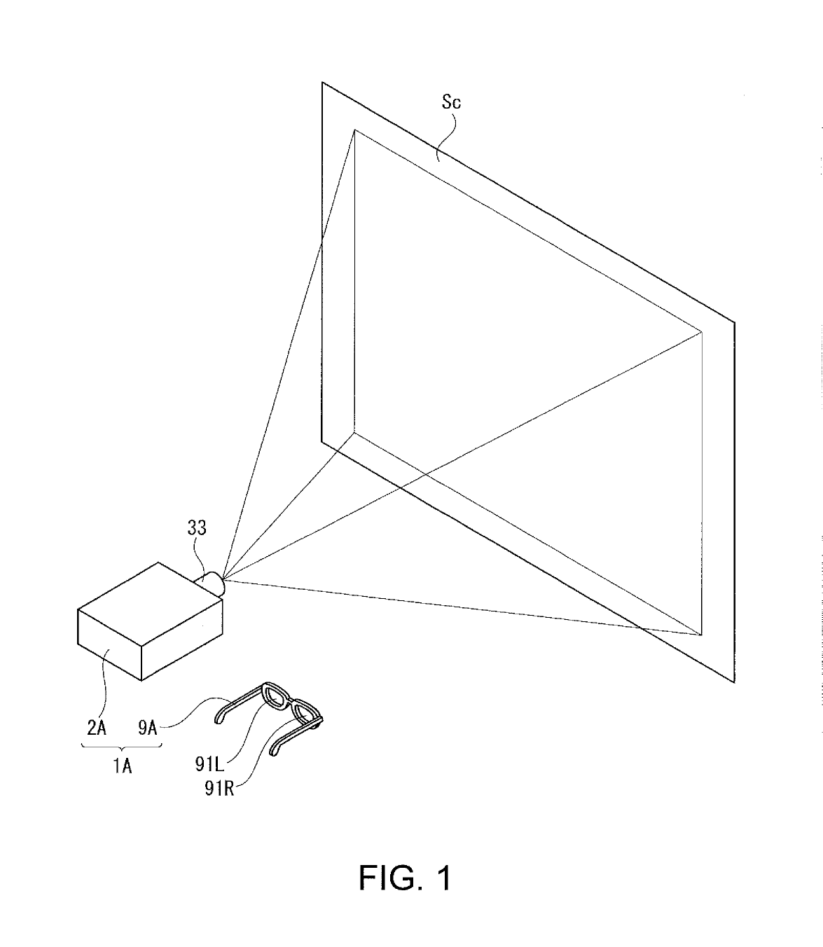

FIG. 1 is a schematic diagram showing a configuration of an image display system 1A according to the present embodiment.

The image display system 1A according to the present embodiment is provided with a projector 2A as a display device for projecting an image on a projection target surface of a screen Sc to thereby display the image, and a pair of glasses 9A worn by the observer.

Among these constituents, the projector 2A is configured so as to be able to switch between the case of displaying a two-dimensional image and the case of alternately displaying a first image and a second image. As such a first image and a second image, a right-eye image and a left-eye image as parallax images to each other can be exemplified. Further, in the case in which the right-eye image and the left-eye image are displayed alternately, the image, which can be viewed stereoscopically due to parallax (hereinafter referred to as a “three-dimensional image”), can be observed by observing the respective images via the pair of glasses 9A.

### Configuration of Glasses

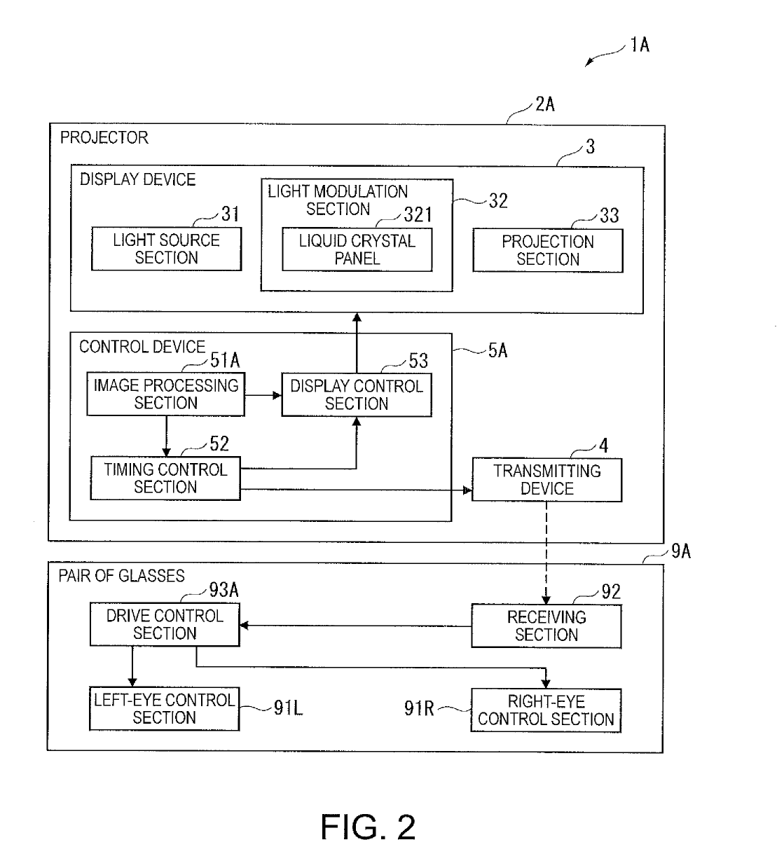

FIG. 2 is a block diagram showing a configuration of the projector 2A and the pair of glasses 9A.

The pair of glasses 9A control the luminance (the light intensity) of the image entering the right eye and the left eye of the observer. Further, in the case of displaying the three-dimensional image described above, the pair of glasses 9A also function as an image separation section for making the right-eye image enter the right eye of the observer, and making the left-eye image enter the left eye of the observer.

As shown in FIG. 2, such a pair of glasses 9A are provided with a right-eye control section 91R, a left-eye control section 91L, a receiving section 92, and a drive control section 93A.

The right-eye control section 91R and the left-eye control section 91L correspond to a transmission state switching section according to the invention, the right-eye control section 91R is disposed so as to correspond to the right eye of the observer wearing the pair of glasses 9A, and the left-eye control section 91R is disposed so as to correspond to the left eye of the observer. These control sections 91R, 91L are each formed of a liquid crystal shutter driven by the drive control section 93A in the present embodiment. In other words, the control sections 91R, 91L are each arranged to have a configuration capable of promptly switching between a state (a transmitting state) of transmitting the light and a state (a blocking state) of hardly transmitting the light unlike a line sequential drive liquid crystal panel.

Although the details will be described later, such a right-eye control section 91R and a left-eye control section 91L each control the luminance of the image observed in one frame by controlling a period (a transmitting period) of the transmitting state in a display period of the image in one frame (hereinafter referred to as “one frame period”) under the control of the drive control section 93A.

Further, by setting the right-eye control section 91R to the transmitting state and setting the left-eye control section 91L to the blocking state during the display period of the right-eye image when displaying the three-dimensional image described above, the right-eye image is made to enter only the right eye. Further, by setting the left-eye control section 91L to the transmitting state and setting the right-eye control section 91R to the blocking state during the display period of the left-eye image, the left-eye image is made to enter only the left eye. Thus, it is possible to observe the right-eye image with the right eye and the left-eye image with the left eye.

The receiving section 92 receives a switching signal transmitted from the projector 2A. The switching signal is a signal for switching between the states (the transmitting state and the blocking state) of each of the right-eye control section 91R and the left-eye control section 91L. In detail, the switching signal gives notice of timing for switching each of the control sections 91R, 91L to the transmitting state and timing for switching each of the control sections 91R, 91L to the blocking state, and thus the period of keeping the transmitting state is indicated. In the present embodiment, such a receiving section 92 is provided with an infrared light receiving element and so on, receives an infrared ray as the switching signal output from the projector 2A, then converts the signal into an electric signal, and then outputs the electric signal to the drive control section 93A.

It should be noted that a signal including the timing for performing switching from the blocking state to the transmitting state and information representing the period (the transmitting period) for keeping the transmitting state can be adopted as the switching signal.

The drive control section 93A applies an ON-voltage or an OFF-voltage to each of the right-eye control section 91R and the left-eye control section 91L based on the signal input from the receiving section 92 to thereby switch the state of each of the control sections 91R, 91L. It should be noted that the drive control of the right-eye control section 91R and the drive control of the left-eye control section 91L performed by the drive control section 93A can individually be performed.

### Configuration of Projector

As described above, the projector 2A is configured so as to be able to switch between the case of displaying a two-dimensional image and the case of displaying a three-dimensional image. As shown in FIG. 2, the projector 2A is provided with a display device 3, a transmitting device 4, and a control device 5A. Further, although not shown in the drawings, the projector 2A is also provided with a power supply section for supplying the electronic components constituting the projector 2A with electricity, and a cooling section for cooling an object of cooling, besides the constituents described above.

The display device 3 forms and then projects the image corresponding to a drive signal input from the control device 5A. The display device 3 is provided with a light source section 31, a light modulation section 32, and a projection section 33.

The light source section 31 illuminates the image forming area of the light modulation section 32. As such a light source section 31, there can be adopted a configuration having a light source lamp such as a super-high pressure mercury lamp, and a reflecting mirror for reflecting the light emitted from the light source lamp while aligning the light in one direction, and can additionally be exemplified a configuration having a solid-state light source such as a light emitting diode (LED) or a laser diode (LD).

The light modulation section 32 modulates the light input from the light source section 31. In the present embodiment, such a light modulation section 32 has a liquid crystal panel 321 as a light modulation device, and forms an image corresponding to the drive signal described above using the liquid crystal panel 321.

Although not shown in FIG. 2, such a liquid crystal panel 321 has a plurality of signal lines and a plurality of scan lines, and a plurality of pixels connected to the signal lines and the scan lines, and one line is constituted by a plurality of pixels connected to each of the scan lines. Further, the liquid crystal panel 321 is driven in a line sequential manner, in which a voltage is applied from the signal line to each of the pixels connected to the scan line selected sequentially, and thus, an image corresponding to one frame is formed. It should be noted that a configuration and a drive method of the liquid crystal panel 321 will be explained later in detail.

The projection section 33 is a projection lens for projecting the image formed by the light modulation section 32 on a projection surface of the screen Sc in an enlarged manner. The projection section 33 is configured as a combination lens having a body tube and a plurality of lenses disposed in the body tube.

The transmitting device 4 transmits a signal (e.g., the switching signal) for controlling the pair of glasses 9A.

Specifically, the transmitting device 4 transmits the switching signal for switching each of the controlling sections 91R, 91L to the transmitting state or the blocking state under the control by a timing control section 52 described later of the control device 5A.

It should be noted that in the present embodiment, the transmitting device 4 is provided with an infrared light emitting diode (LED) and a drive circuit for lighting the infrared LED, and transmits the switching signal described above with the emission period and the emission pattern changed.

The control device 5A controls the overall operation of the projector 2A including the display device 3, and further controls the operation of the pair of glasses 9A by making the transmitting device 4 transmit the switching signal described above. The control device 5A is configured as a circuit board having a central processing unit (CPO), a read only memory (ROM), a random access memory (RAM), and so on mounted thereon. Further, the control device 5A functions as an image processing section 51A, the timing control section 52, and a display control section 53 due to the CPU executing a program stored in the ROM.

The image processing section 51A processes image data (including the image signal) received from the outside, and then draws the image corresponding to one frame based on the image data in a frame memory (not shown). Such image data is formed of an aggregate of data each representing one frame, and includes sync signals (a vertical sync signal and a horizontal sync signal). It should be noted that the image data of a three-dimensional image includes the data of the left-eye image and the data of the right-eye image.

The timing control section 52 reads the sync signals included in the image data processed by the image processing section 51A. Then, the timing control section 52 outputs control signals respectively to the display control section 52 and the transmitting device 4 to thereby control the image forming timing by the liquid crystal panel 321 and the output timing of the switching signal described above by the transmitting device 4. On this occasion, the timing control section 52 generates a sub-frame sync signal with the frequency set to an integral multiple of the frequency of the vertical sync signal included in the sync signals, and then outputs the sub-frame sync signal to the display control section 53.

Further, the timing control section 52 corresponds to a transmitting period control device according to the invention, and controls the transmitting period of each of the control sections 91R, 91L described above frame by frame by controlling the output timing of the switching signal to thereby control the luminance of the image observed by the observer frame by frame. The control of the transmitting period by the timing control section 52 will be described later in detail.

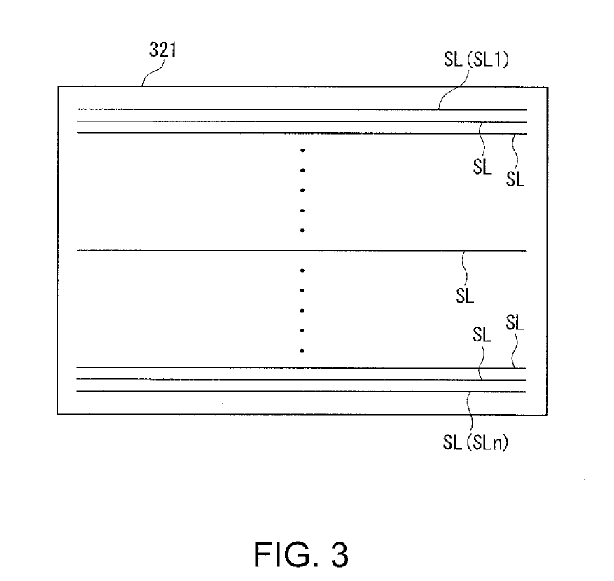

FIG. 3 is a schematic diagram for explaining the drive method of the liquid crystal panel 321.

The display control section 53 drives the liquid crystal panel 321 in a line sequential manner to thereby make the liquid crystal panel 321 form the image drawn by the image processing section 51A.

Specifically, as shown in FIG. 3, the display control section 53 sequentially selects one of the scan lines from the top scan line SL (the scan line SL1 to be selected first) to the bottom scan line SL (the scan line SLn to be selected last) based on the sync signal input from the timing control section 52. Then, the display control section 53 applies a voltage corresponding to the grayscale of the image thus drawn to (writes the image data into) each of the pixels connected to the scan line SL thus selected via a signal line (not shown). Thus, the image provided to the liquid crystal panel 321 is updated.

It should be noted that in the present embodiment, the display control section 53 forms and then displays a sub-frame based on the same frame a plurality of times in one frame period indicated by the vertical sync signal included in the image data.

Specifically, in the case in which the image signal with a predetermined frequency is input to the image processing section 51, the sub-frame sync signal with a frequency obtained by performing integral multiplication on the predetermined frequency is input from the timing control section 52 to the display control section 53. Then, the display control section 53 drives the liquid crystal panel 321 in accordance with the sub-frame sync signal to thereby form the sub-frame a plurality of times in one frame period.

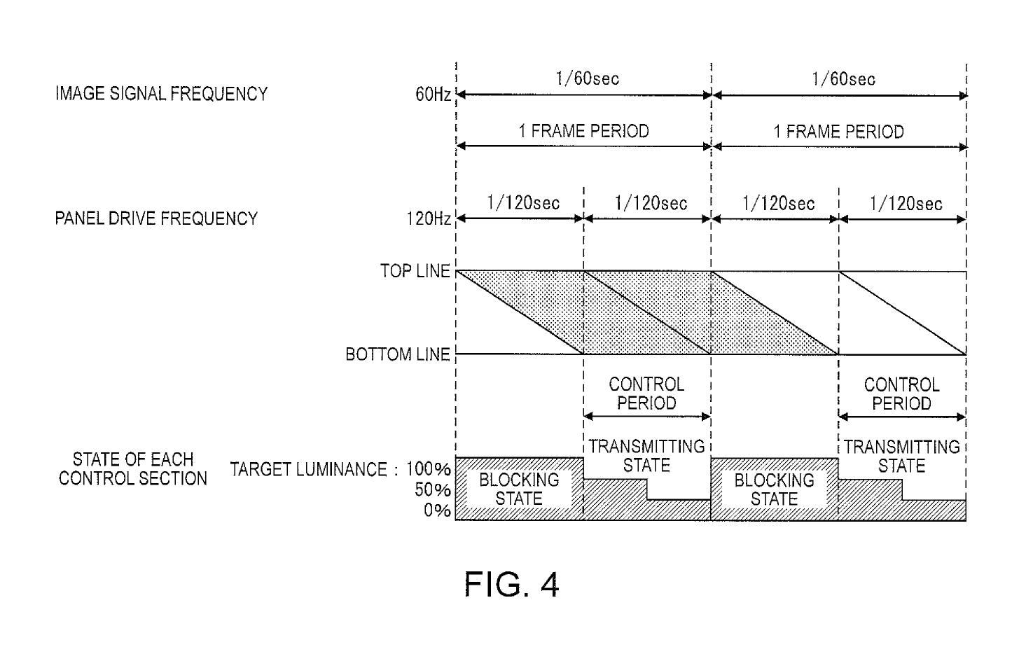

FIG. 4 is a diagram showing an example of a relationship between the image forming period by the liquid crystal panel 321 and the states (the transmitting state and the blocking state) of each of the control sections 91R, 91L when displaying a two-dimensional image. In the middle part of FIG. 4, there is shown the timing for applying the voltage corresponding to the grayscale to each of the lines of the liquid crystal panel 321 sequentially from the top line toward the bottom line. It should be noted that although one cycle (a period in which the image data corresponding to one frame is input) of the image signal input and two cycles of image formation by the liquid crystal panel 321 are synchronized with each other in FIG. 4 for the sake of explanation, it is not necessarily required to synchronize these cycles with each other. The same applies also to the following explanation.

For example, as shown in FIG. 4, in the case in which the image signal of 60 Hz (the image signal of which the period of inputting the image data of one frame is 1/60 second) is input, the display control section 53 drives the liquid crystal panel 321 at 120 Hz, which is twice as high as the frequency of the image signal, based on the sub-frame sync signal input from the timing control section 52. Then, the display control section 53 forms the sub-frame corresponding to the frame thus input twice in one frame period ( 1/60 second). In this case, the display image corresponding to one frame is composed of two sub-frames.

As a method of forming such sub-frames, there can be cited, for example, the two methods described below.

The first is a method in which the display control section 53 reads the image corresponding to one frame drawn in the frame memory by the image processing section 51A, and then applies the voltage based on the image to each of the pixels at the forming timing of the sub-frames described above to thereby sequentially form the sub-frames.

The second is a method in which the image processing section 51A draws the frame input thereto to each of the plurality of drawing areas to be read sequentially in the frame memory, and then the display control section 53 sequentially performs reading of the image drawn in each of the drawing areas and voltage application to each of the pixels at the forming timing of the sub-frames described above.

In the case of using either one of these methods, a plurality of sub-frames can be formed and then displayed in one frame period.

Luminance Control of Image to be Observed

In the state in which the plurality of sub-frames are sequentially displayed as described above, the timing control section 52 controls the transmitting period of each of the control sections 91R, 91L in one frame period to thereby control the luminance of the image to be observed.

Specifically, the timing control section 52 controls the period during which each of the control sections 91R, 91L is in the transmitting state in the period from when the display of the sub-frame (a first sub-frame) displayed first in one frame period is completed to when the subsequent one frame period starts, to thereby control the luminance of the image to be observed.

It should be noted that the time when the display of the sub-frame is completed can be defined as the timing at which the voltage corresponding to the image drawn is applied to each of the pixels connected to the bottom scan line SLn, or the timing at which the grayscale of the sub-frame is completely switched to the grayscale corresponding to the image drawn.

Hereinafter, the luminance control method in the case of displaying a two-dimensional image and in the case of displaying a three-dimensional image will be explained.

Luminance Control when Displaying Two-Dimensional Image

In the example shown in FIG. 4, in the case in which the target luminance of the two-dimensional image to be observed is set to 100%, the timing control section 52 sets the period (the transmitting period), during which each of the control sections 91R, 91L is set to the transmitting state in one frame period, to the entire period (hereinafter referred to as a “control period”) from when the display of the first sub-frame in the one frame period is completed to when the subsequent one frame period starts.

Further, in the case in which the target luminance of the image to be observed is set to 0%, the timing control section 52 sets the transmitting period in the control period described above to 0. In other words, the timing control section 52 arranges that each of the control sections 91R, 91L is in the blocking state in the entire control period described above.

Further, in the case in which the target luminance of the image to be observed is set to 50%, the timing control section 52 sets the transmitting period described above to the period corresponding to 50% of the control period described above.

Further, the timing control section 52 makes the transmitting device 4 transmit the switching signal for switching each of the control sections 91R, 91L from the blocking state to the transmitting state in sync with the beginning of the transmitting period thus set, and then makes the transmitting device 4 transmit the switching signal for switching each of the control sections 91R, 91L from the transmitting state to the blocking state in sync with the end of the transmitting period. Thus, each of the control sections 91R, 91L is set to the transmitting state only in the transmitting period thus set to thereby control the luminance of the image to be observed by the observer.

Here, it is not necessarily required to synchronize the start timing (the timing for switching each of the control sections 91R, 91L to the transmitting state) of the transmitting period with the time when the display of the first sub-frame is completed. However, it takes little time for each of the control sections 91R, 91L to be completely switched from the transmitting state to the blocking state and from the blocking state to the transmitting state.

Therefore, if the end timing of the transmitting period is close to the subsequent one frame period, there can arise the possibility that each of the control sections 91R, 91L is not completely switched to the blocking state despite the fact that the display of the first sub-frame has already started in the subsequent one frame period. On this occasion, the image mixed with the first sub-frame is problematically observed.

In contrast, by making the start timing of the transmitting period close to the time when completing the display of the first sub-frame to thereby elongate the transmitting period as long as possible, and at the same time, shifting forward the end timing of the transmitting period (the switching timing to the blocking state) from the time when starting the subsequent one frame period, it is possible to prevent the image from being observed while being mixed with an image of another frame.

Similarly, the reason that each of the control sections 91R, 91L is set to the transmitting state after completing the display of the first sub-frame is to prevent a part of another frame displayed previously from being observed in a mixed manner.

However, in the case of displaying a two-dimensional image, the same image is observed in the right eye and the left eye of the observer, and therefore, even if a part of the previous frame and a part of the following frame are observed in a mixed manner, it does not matter so much.

Therefore, if the problem that a part of another frame is observed in a mixed manner is left out of consideration, it is possible to control the luminance of the image to be observed by the right eye and the left eye by setting the period from the beginning of the display of the first sub-frame to the beginning of the subsequent frame period as the control period, and controlling the transmitting period described above in the control period.

Luminance Control when Displaying Three-Dimensional Image

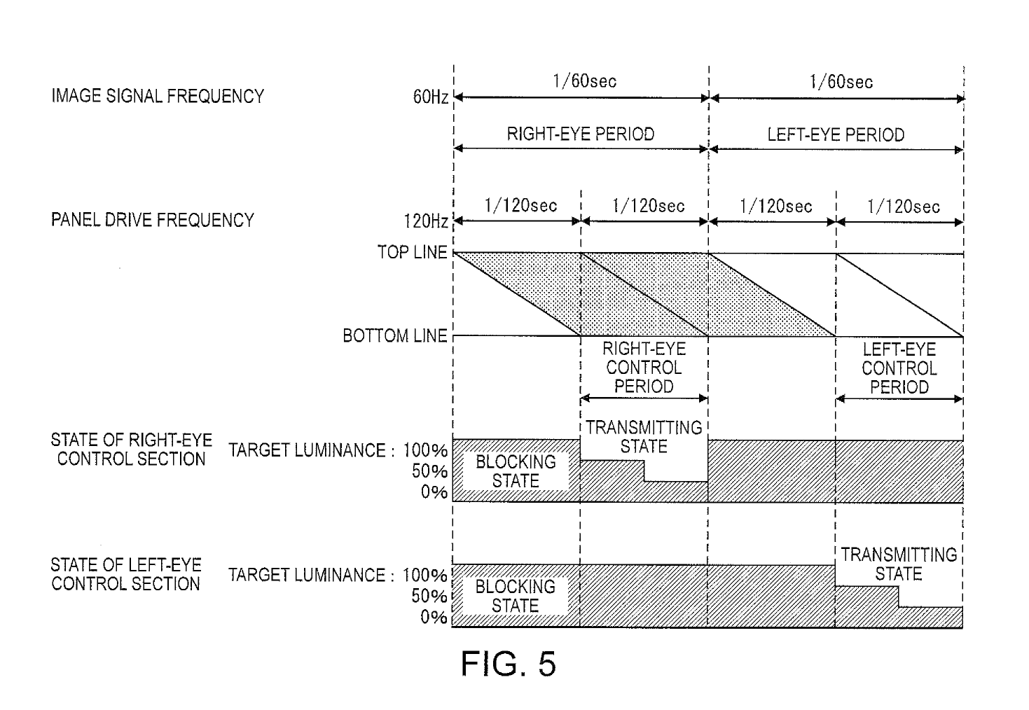

FIG. 5 is a diagram showing an example of a relationship between the image forming period by the liquid crystal panel 321 and the states of each of the control sections 91R, 911, when displaying a three-dimensional image. It should be noted that FIG. 5 shows an example of the case of driving the liquid crystal panel 321 at 120 Hz.

In the case of displaying a three-dimensional image, the image processing section 51A described above obtains the right-eye image and the left-eye image from the image data received, and then draws the images individually in the frame memory.

Meanwhile, the display control section 53 obtains each of the right-eye image and the left-eye image drawn in the frame memory. Then, as shown in FIG. 5, the display control section 53 forms a plurality of sub-frames corresponding to the right-eye image in one frame period, and then forms a plurality of sub-frames corresponding to the left-eye image in the subsequent one frame period based on the sub-frame sync signal input from the timing control section 52. In other words, the right-eye image and the left-eye image are displayed alternately.

Specifically, in the present embodiment, the image signal at 60 Hz is input to the image processing section 51A, and the display control section 53 drives the liquid crystal panel 321 at 120 Hz based on the sub-frame sync signal described above. Then, the display control section 53 sequentially forms the two sub-frames corresponding to the right-eye image thus obtained in one frame period, and then sequentially forms the two sub-frames corresponding to the left-eye image thus obtained in the subsequent one frame period. Thus, the projector 2A displays the right-eye image and the left-eye image alternately.

The timing control section 52 makes the transmitting device 4 transmit the switching signal for switching the right-eye control section 91R to the transmitting state at the timing after completing the display of the first sub-frame first displayed in one frame period (hereinafter referred to as a “right-eye period”) for displaying the right-eye image.

Further, the timing control section 52 makes the transmitting device 4 transmit the switching signal for switching the left-eye control section 91L to the transmitting state at the timing after completing the display of the first sub-frame first displayed in one frame period (hereinafter referred to as a “left-eye period”) for displaying the left-eye image.

On the other hand, the timing at which the timing control section 52 makes the transmitting device 4 transmit the switching signal for switching the right-eye control section 91R to the blocking state in the right-eye period is controlled in accordance with the target luminance of the image to be observed similarly to the case of displaying the two-dimensional image described above.

For example, in the case in which the target luminance of the right-eye image observed is set to 100%, the timing control section 52 sets the transmitting period of the control section 91R in the right-eye period to the whole of a period (hereinafter referred to as a “right-eye control period”) set between the completion of the display of the first sub-frame of the right-eye period and the beginning of the display of the subsequent frame.

Further, in the case in which the target luminance of the right-eye image to be observed is set to 0%, the timing control section 52 sets the transmitting period of the control section 91R in the right-eye control period described above to 0. In other words, the transmitting period is set so that the control section 91R is set to the blocking state in the entire right-eye control period described above.

Incidentally, in the case in which the target luminance of the right-eye image to be observed is set to 50%, the timing control section 52 sets the transmitting period of the control section 91R in the right-eye control period to the period corresponding to 50% of the right-eye control period.

Then, the timing control section 52 makes the switching signal for switching the right-eye control section 91R to the transmitting state be transmitted when completing the display of the first sub-frame in the right-eye period (at the beginning of the right-eye control period). Subsequently, the timing control section 52 makes the switching signal for switching the right-eye control section 91R to the blocking state be transmitted at the end of the transmitting period. In the right-eye period, a switching signal for switching the left-eye control section 91L to the transmitting state is not transmitted.

Thus, the integrated value of the light entering the right eye of the observer in the right-eye period varies in accordance with the length of the transmitting period of the right-eye control section 91R, and therefore, the luminance of the right-eye image to be observed is controlled.

It should be noted that the transmitting period of the left-eye control section 91L with respect to the period (hereinafter referred to as a “left-eye control period”) set between the completion of the display of the first sub-frame displayed first in the left-eye period and the beginning of the subsequent one frame period is also set similarly. Further, the transmission of the switching signal for switching the left-eye control section 91L to the transmitting state, and the switching signal for switching the left-eye control section 91L to the blocking state is also performed similarly.

Here, when displaying a three-dimensional image, the start timing (the timing for switching each of the control sections 91R, 91L to the transmitting state) of the transmitting period of each of the control sections 91R, 91L is set after completing the display of the first sub-frame as described above.

This is because unlike the display of a two-dimensional image described above, it is necessary to make the right-eye image enter the right eye of the observer and make the left-eye image enter the left eye when displaying a three-dimensional image.

For example, as shown in FIG. 5, at the beginning of the display of the first sub-frame in the right-eye period, the voltage corresponding to the grayscale of the first sub-frame is applied to each of the pixels on the top line side of the liquid crystal panel 321 driven by the line sequential method to thereby start forming the first sub-frame. However, on the bottom line side at this moment, there is a state in which the voltage corresponding to the grayscale of the last sub-frame in the previous left-eye period remains applied to each of the pixels. Therefore, if the right-eye control section 91R is set to the transmitting state before completing the formation of the first sub-frame, an image having the right-eye image and the left-eye image mixed with each other is problematically observed. Such a phenomenon is called cross talk, and if the cross talk occurs, there is a possibility of failing to appropriately observe the three-dimensional image.

In contrast, by setting the transmitting period of each of the control sections 91R, 91L after completing the display of the first sub-frame in each of the right-eye period and the left-eye period, the cross talk can be inhibited from occurring.

In particular, in the present embodiment, the start timing of the transmitting period described above is set to the completion of the display of the first sub-frame. The purpose thereof is to shift forward the end timing of the transmitting period from the start timing of the subsequent frame period as much as possible even in the case in which the length of the transmitting period is the same as described above.

Specifically, since the switching of the state of each of the control sections 91R, 91L is not instantaneously performed, but takes little time, the end point of the transmitting period described above is shifted forward from the start point of the subsequent frame period as much as possible so that the image including the right-eye image and the left-eye image mixed with each other is not observed (so that the cross talk does not occur).

### Drive of Liquid Crystal Panel at Another Frequency

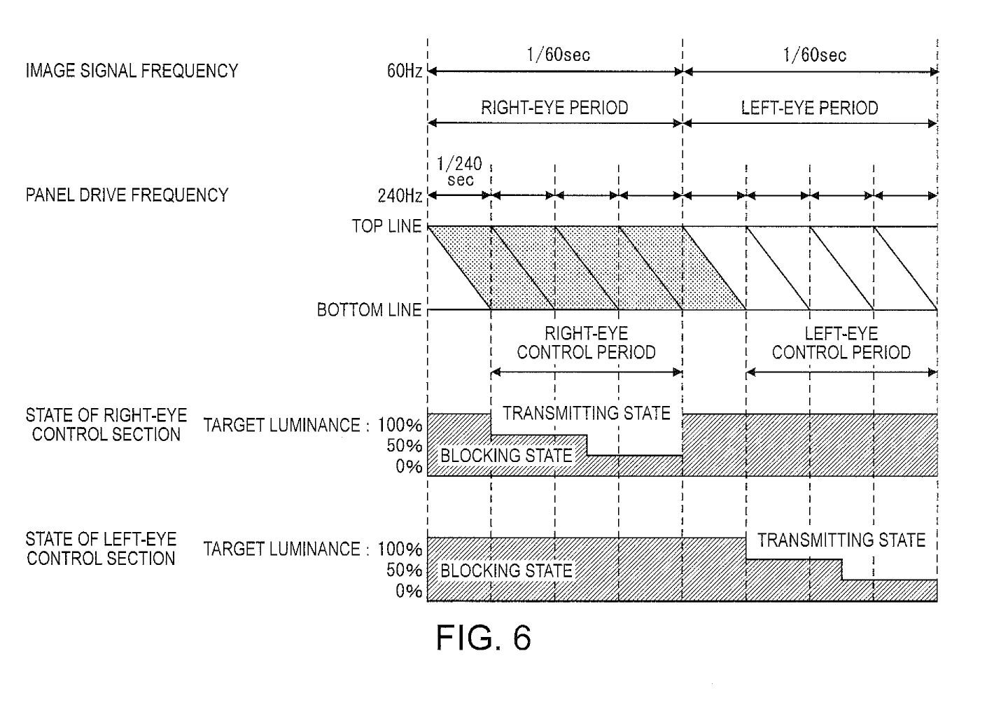

FIG. 6 is a diagram showing an example of the relationship between the image forming period by the liquid crystal panel 321 and the states of each of the control sections 91R, 91L when displaying a three-dimensional image. It should be noted that FIG. 6 shows an example of the case of driving the liquid crystal panel 321 at 240 Hz.

As described above, the liquid crystal panel 321 is driven at a frequency of an integral multiple of the signal frequency input thereto. Therefore, it is also possible to drive the liquid crystal panel 321 at 240 Hz four times as high as the signal frequency to thereby form four sub-frames in one frame period as shown in FIG. 6.

In such a case, the right-eye control period and the left-eye control period can be elongated compared to the case of driving the liquid crystal panel 321 at 120 Hz, although the length of the one frame period (the right-eye period and the left-eye period) is the same. Therefore, since the control range of the transmitting period described above can be enlarged, the control range of the luminance of the image to be observed can be broadened compared to the case of driving the liquid crystal panel 321 at 120 Hz.

According to the image display system 1A related to the present embodiment explained hereinabove, the following advantages can be obtained.

The timing control section 52 as a transmitting period control device controls the transmitting period of the right-eye control section 91R and the left-eye control section 91L as a transmitting state switching device in one frame period. According to this configuration, the luminance of the image to be observed via the right-eye control section 91R and the left-eye control section 91L can be controlled.

The display control section 53 makes the liquid crystal panel 321 form a plurality of sub-frames in one frame period, and the timing control section 52 sets the timing, at which the transmitting period of the corresponding one of the control sections 91R, 91L starts, to the time point after completing the display of the first sub-frame displayed first in the right-eye period or the left-eye period.

According to this configuration, for example, when completing the display of the first sub-frame in the right-eye period, the switching from the sub-frame of the left-eye image having previously been displayed to the first sub-frame (i.e., the sub-frame of the right-eye image) is completed. Therefore, by setting the timing, at which the transmitting state of the right-eye control section 91R begins, to the time point on and after the completion of the display of the first sub-frame in the right-eye period, the right-eye image with no left-eye image mixed can be observed. Therefore, the cross talk can be inhibited from occurring. The same applies to the timing at which the transmitting period begins in the left-eye period.

The timing control section 52 controls the length of the transmitting period of each of the control sections 91R, 91L frame by frame (every one frame period). According to this configuration, the luminance of the image to be observed can be controlled frame by frame. Further, in the case in which the projector 2A alternately displays the right-eye image and the left-eye image, it is possible to easily match the luminance of the respective images with each other. In contrast, in the case in which the projector 2A alternately displays a first image and a second image different from each other, it is also possible to make the luminance of the first image to be observed and the luminance of the second image to be observed different from each other.

In the pair of glasses 9A, the right-eye control section 91R and the left-eye control section 91L as the transmitting state switching device are each provided with a liquid crystal shutter. According to this configuration, the switching between the transmitting state and the blocking state of each of the control sections 91R, 91L can be performed with relative promptness. Therefore, it is possible to make it easy to control the luminance of the image to be observed to a desired luminance.

### Second Embodiment

Then, a second embodiment of the invention will be explained.

The image display system according to the present embodiment is provided with substantially the same configuration as that of the image display system 1A described above, but is different from the image display system 1A in the point that the present image display system is configured so as to be able to control the light transmittance of each of the control sections provided to the pair of glasses. It should be noted that in the explanation below, the part which is the same or substantially the same as the part having already been explained is denoted with the same reference symbol, and the explanation therefor will be omitted.

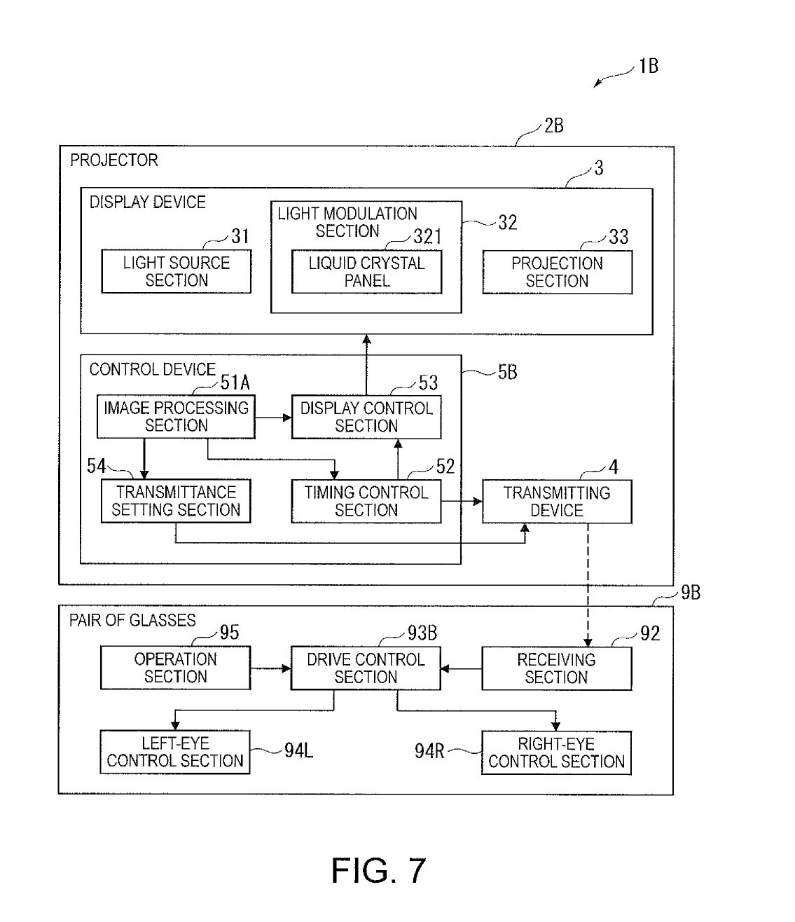

FIG. 7 is a block diagram showing a configuration of the image display system 1B according to the present embodiment.

As shown in FIG. 7, the image display system 1B according to the present embodiment is provided with a projector 2B as a display device for projecting an image on the screen Sc (see FIG. 1) to thereby display the image, and a pair of glasses 9B worn by the observer.

The pair of glasses 9B have substantially the same configuration and function as those of the pair of glasses 9A except the fact that a right-eye control section 94R and a left-eye control section 94L are provided instead of the right-eye control section 91R and the left-eye control section 91L, a drive control section 93B is provided instead of the drive control section 93A, and an operation section 95 is further provided.

The right-eye control section 94R and the left-eye control section 94L are each formed of a liquid crystal shutter the operation of which is controlled by the drive control section 93B similarly to the control sections 91R, 91L described above. However, each of the control sections 94R, 94L is configured so as to be able to control the light transmittance in the case in which each of the control sections 94R, 94L is in the transmitting state in addition to switching between the transmitting state and the blocking state. Such states and light transmittance of each of the control sections 94R, 94L are controlled by the drive control section 93B.

The operation section 95 is provided to a frame of the pair of glasses 9B, and receives operations for controlling the light transmittance of each of the control sections 94R, 94L. The operation section 95 outputs an operation signal corresponding to the operation to the drive control section 93B.

The drive control section 93B switches the state of each of the control sections 94R, 94L based on the switching signal received by the receiving section 92 similarly to the drive control section 93A described above. Further, the drive control section 933 corresponds to a transmittance control device according to the invention, and controls the light transmittance of each of the control sections 94R, 94L to the light transmittance indicated by the setting signal also received by the receiving section 92 when setting each of the control sections 94R, 94L to the transmitting state. Further, the drive control section 933 controls the light transmittance of each of the control sections 94R, 94L in accordance with the operation signal input from the operation section 95. Therefore, the light transmittance of each of the control sections 94R, 94L can be controlled by the observer.

The projector 23 has substantially the same configuration and function as those of the projector 2A except the point that a control device 5B is provided instead of the control device 5A.

The control device 53 is provided with a transmittance setting section 54 in addition to the image processing section 51A, the timing control section 52, and the display control section 53 described above.

The transmittance setting section 54 makes the transmitting device 4 transmit a setting signal for setting the light transmittance of each of the control sections 94R, 94L. Such light transmittance can also be set by the transmittance setting section 54 in accordance with a display mode (e.g., a normal mode, a cinema mode, and a dynamic mode) set by the observer, or can be set in accordance with the image drawn by the image processing section 51A. On this occasion, it is also possible to set the light transmittance based on, for example, an average luminance level of the image. Further, it is also possible to set the light transmittance in accordance with the input operation of the observer to the operation device (not shown) such as a variety of types of buttons provided to the projector 2B.

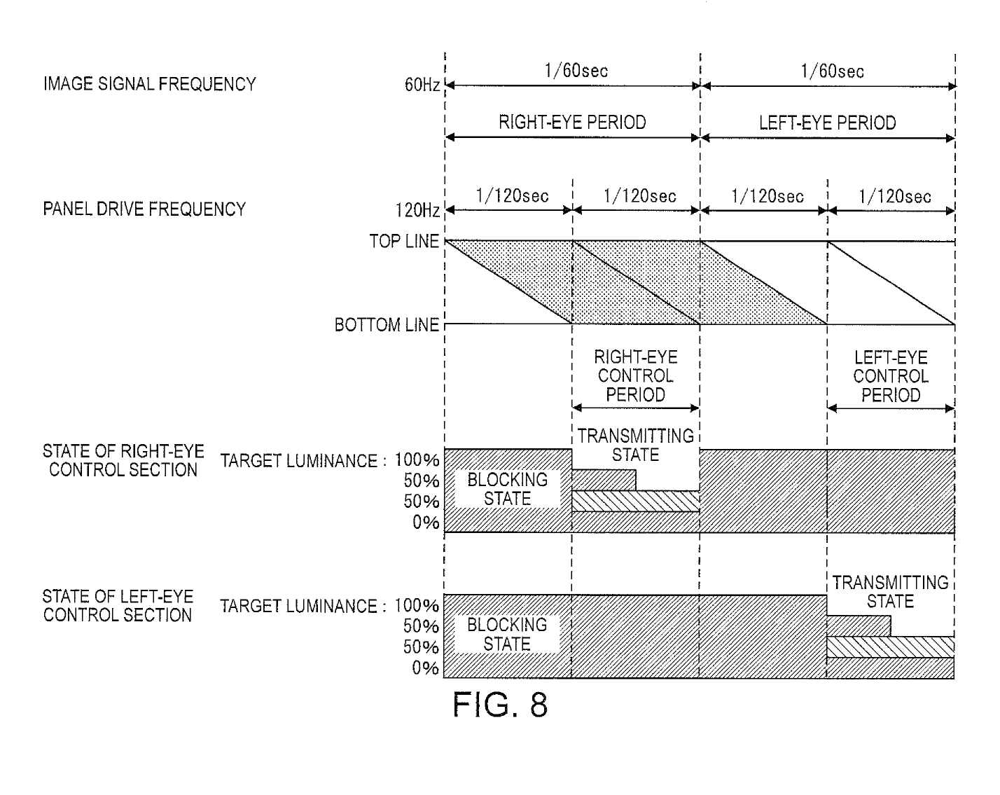

FIG. 8 is a diagram showing an example of the relationship between the image forming period by the liquid crystal panel 321 and the states of each of the control sections 94R, 94L when displaying a three-dimensional image in the image display system 1B. It should be noted that FIG. 8 shows an example of the case of driving the liquid crystal panel 321 at 120 Hz.

When the projector 2B displays a three-dimensional image, each of the control sections 94R, 94L of the pair of glasses 9B is switched to either of the transmitting state or the blocking state. When switched to the transmitting state, the light transmittance of each of the control sections 94R, 94L is controlled under the control of the drive control section 93B.

For example, as shown in the lower part of the place indicated as “TARGET LUMINANCE 50%” in FIG. 8, in the case of setting the target luminance of the right-eye image to be observed to 50%, the entire right-eye control area described above is set as the transmitting period of the right-eye control section 94R, and further, the light transmittance of the right-eye control section 94R is set to 50%. Further, in the case of setting the target luminance of the left-eye image to be observed to 50%, the entire left-eye control period is set as the transmitting period of the left-eye control section 94L, and further, the light transmittance of the left-eye control section 94L is set to 50%. Further, in the case of setting the target luminance to another value, the entire control period is similarly set as the transmitting period of the corresponding one of the control sections, and the light transmittance of the control section is set to the another proportion described above.

The luminance control of the observation image due to the control of the light transmittance of each of the control sections 94R, 94L described above can also be performed in the case of displaying a two-dimensional image in a similar manner. Further, by controlling the transmitting period in combination with the control of the light transmittance described above, a finer luminance control can be performed.

It should be noted that as shown in the upper part of the place indicated as “target luminance 50%” in FIG. 8, in the image display system 1B according to the present embodiment, it is possible to control the luminance of the image to be observed also by setting the light transmittance of corresponding one of the control sections 94R, 94L to 100% in the right-eye period or the left-eye period and controlling the transmitting period described above.

Further, in the example shown in FIG. 8, the liquid crystal panel 321 is driven at 120 Hz with respect to the image signal of 60 Hz, to thereby form two sub-frames in one frame period. However, besides the above, the same can be applied to the case of adopting a configuration in which the liquid crystal panel 321 is driven at a frequency, which is an integral multiple equal to or greater than three times of the signal frequency of the image signal, to thereby form and then display a larger number of sub-frames. For example, it is possible to form three sub-frames by driving the liquid crystal panel 321 at 180 Hz, or to form four sub-frames by driving the liquid crystal panel at 240 Hz.

According to the image display system 1B related to the present embodiment explained hereinabove, in addition to the advantages substantially the same as those of the image display system 1A described above, the following advantages can be obtained.

The right-eye control section 94R and the left-eye control section 94L are each configured so as to be able to control the light transmittance. Further, the drive control section 93B as the transmittance control device controls the light transmittance of each of the control sections 94R, 94L to the light transmittance set previously.

According to this configuration, the luminance control of the image to be observed via each of the control sections 94R, 94L can more finely be set, and in addition, the luminance control can be performed by each observer who wears the pair of glasses 9B.

Further, it is also possible for the drive control section 93B to control the light transmittance of each of the control sections 94R, 94L in accordance with the operation by the observer to the operation section 95. According to this configuration, in the case of performing the luminance control for each pair of glasses 9B, it is unnecessary to transmit the setting signal for setting the light transmittance from the projector 2B to each of the pairs of glasses 9B. Therefore, the configuration and the process of the projector 2B and the pair of glasses 9B can be simplified. Further, since it is possible to integrate the signals transmitted by the projector 2B into the switching signals for switching the states of the respective control sections 94R, 94L, even in the case in which the luminance control is performed by each of the observers, it is possible to make the pairs of glasses 9B operate in sync with each other in a reliable manner.

### Third Embodiment

Then, a third embodiment of the invention will be explained.

An image display system according to the present embodiment is provided with substantially the same configuration as that of the image display system 1B described above, and is further configured so as to be able to control the luminance of the image to be observed by controlling the luminance of the sub-frames. In this point, the image display system according to the present embodiment and the image display system 18 are different from each other. It should be noted that in the explanation below, a part which is the same or substantially the same as the part having already been explained is denoted with the same reference symbol, and the explanation therefor will be omitted.

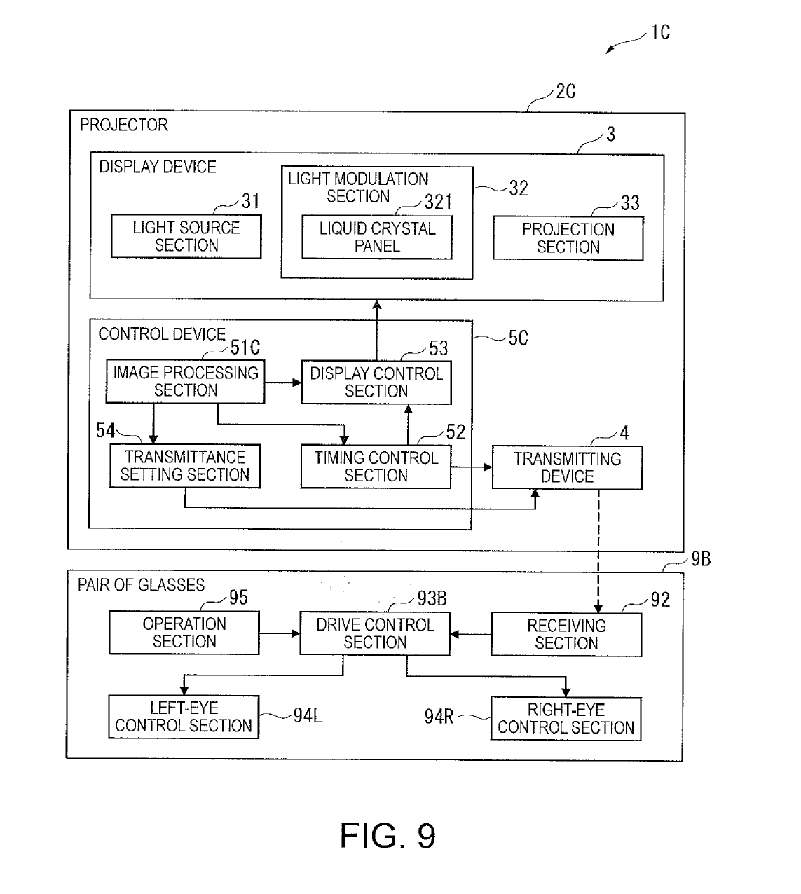

FIG. 9 is a block diagram showing a configuration of the image display system 10 according to the present embodiment.

The image display system 10 according to the present embodiment is provided with a projector 2C as the display device, and the pair of glasses 9B. Further, the projector 2C has substantially the same configuration and function as those of the projector 2B described above except the point that a control device 50 is provided instead of the control device 5B, and the control device 5C has substantially the same configuration and function as those of the control device 5B except the point that an image processing section 510 is provided instead of the image processing section 51A.

It should be noted that in the following explanation, it is assumed that the image signal of 60 Hz is received by the projector 2C, and the display control section 53 drives the liquid crystal panel 321 at 240 Hz four times as high as the signal frequency of the image signal for the sake of convenience of explanation. However, the signal frequency of the image signal and the drive frequency of the liquid crystal panel 321 are not limited to the numerical values.

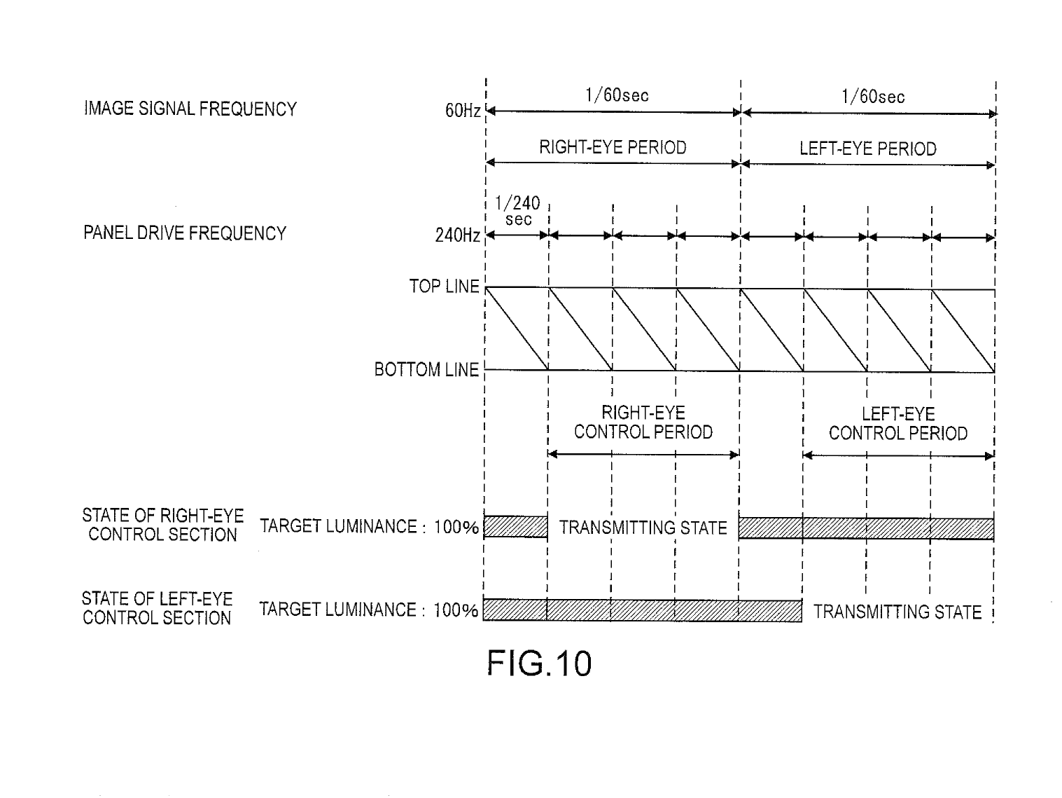

FIGS. 10 through 13 are diagrams showing an example of the relationship between the image forming period by the liquid crystal panel 321 and the states of each of the control sections 94R, 94L when displaying a three-dimensional image.

Similarly to the image processing section 51A described above, the image processing section 51C processes image data, and then draws the image corresponding to one frame based on the image data in a frame memory (not shown). On this occasion, as shown in FIG. 10, the image processing section 51B draws four sub-frames in one frame period, and increases or decreases the luminance of at least one of these sub-frames from the luminance based on the image data.

Specifically, when drawing the four sub-frames in the frame memory, the image processing section 51C makes the grayscale (luminance) of the first sub-frame to be displayed first in one frame period and the grayscale of the fourth sub-frame (the last sub-frame) to be displayed last equal to each other, and increases or decreases the grayscales of the second sub-frame and the third sub-frame.

For example, in the case of setting the target luminance of the right-eye image to be observed to 100%, the luminance of the first through fourth sub-frames displayed in the right-eye period is set to the value based on the image data, and the entire right-eye control period described above is set to the transmitting period of the right-eye control section 94R as shown in FIG. 10. The image observed in this case is the image displayed with the maximum luminance.

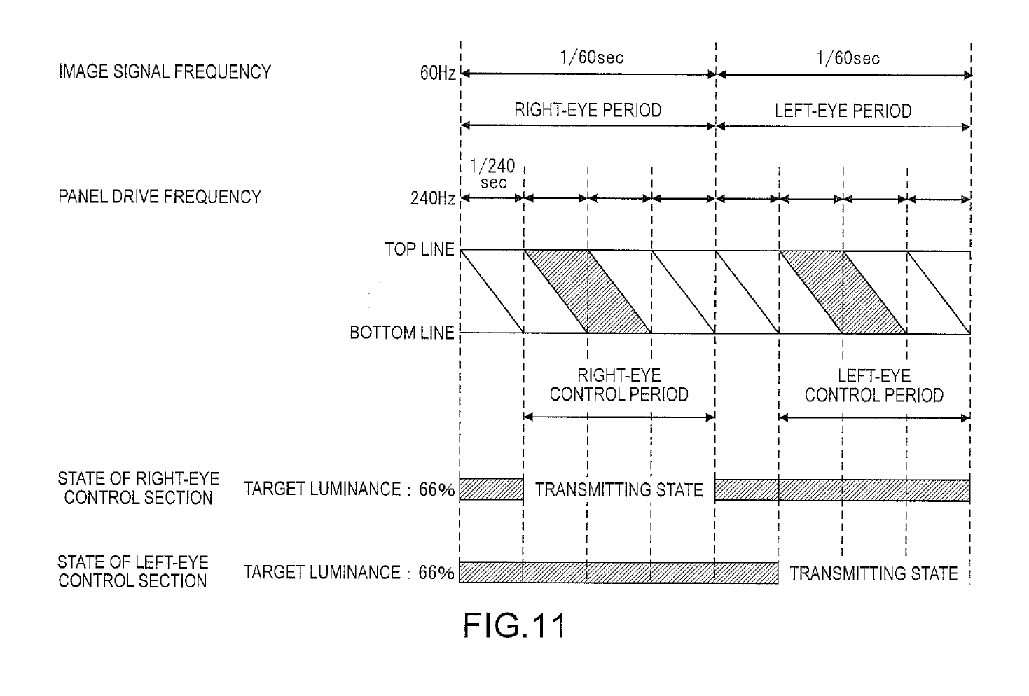

Further, in the case of, for example, setting the target luminance of the right-eye image to be observed to 66%, the grayscales of the first and fourth sub-frames of the first through fourth sub-frames displayed in the right-eye period are set to the value based on the image data, the grayscale of either one of the second and third sub-frames is set to the value based on the image data, and the grayscale of the other is set to the lowest value (the grayscale value corresponding to the darkest image) as shown in FIG. 11. Further, in a similar manner, the entire right-eye control period is set to the transmitting period of the right-eye control section 94R. It should be noted that in the example shown in FIG. 11, the grayscale of the second sub-frame is set to the lowest value (with the luminance of 0%).

In such a case, since the image with the luminance of 0% is displayed in a third of the right-eye control period, and the image with the luminance of 100% is displayed in the rest, namely two thirds thereof, the observer observes the right-eye image, which has the luminance of 66% with respect to the image displayed with the maximum luminance, with the right eye.

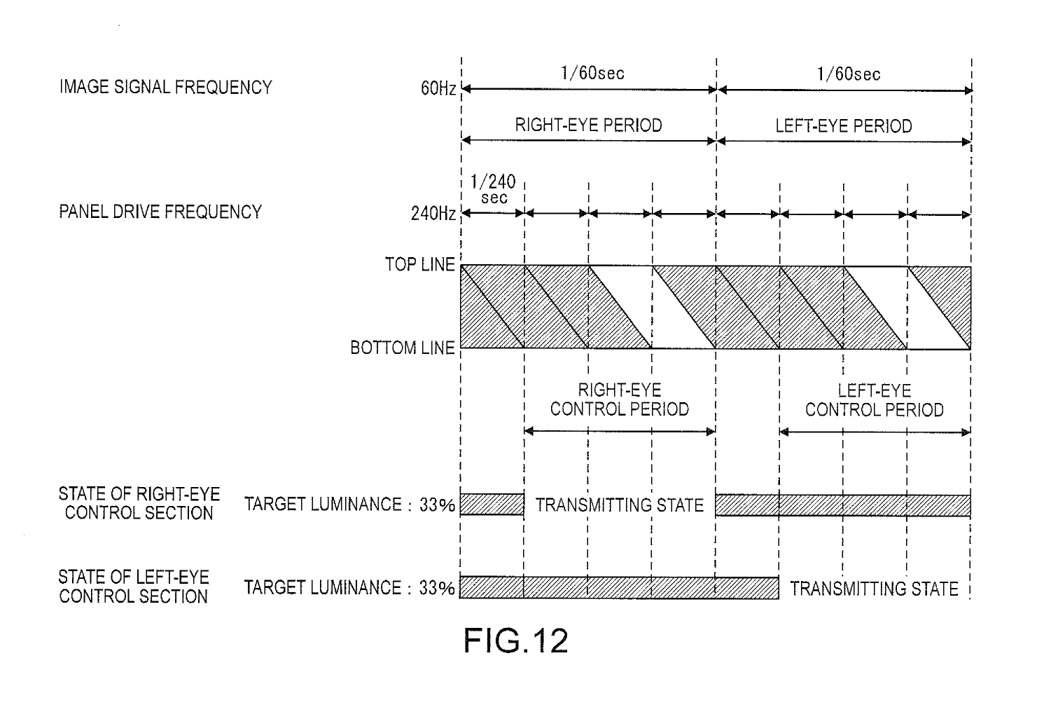

Further, in the case of, for example, setting the target luminance of the right-eye image to be observed to 33%, the grayscales of the first and fourth sub-frames of the first through fourth sub-frames displayed in the right-eye period are set to the lowest value, the grayscale of either one of the second and third sub-frames is set to the value based on the image data, and the grayscale of the other is set to the lowest value as shown in FIG. 12. Further, in a similar manner, the entire right-eye control period is set to the transmitting period of the right-eye control section 94R. It should be noted that in the example shown in FIG. 12, the grayscale of the second sub-frame is set to the lowest value (with the luminance of 0%).

In such a case, since the image with the luminance of 100% is displayed in a third of the right-eye control period, and the image with the luminance of 0% is displayed in the rest, namely two thirds thereof, the observer observes the right-eye image, which has the luminance of 33% with respect to the image displayed with the maximum luminance, with the right eye.

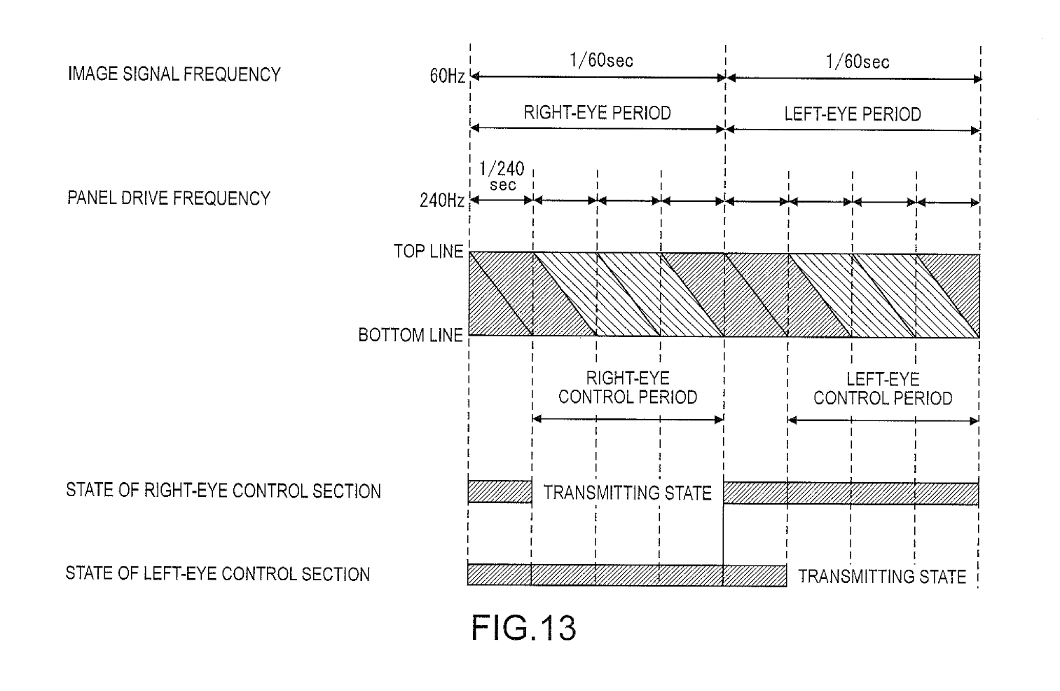

Further, as shown in FIG. 13, in the case of setting the luminance (the target luminance) of the right-eye image to be observed to a lower value, the grayscales of the first and fourth sub-frames of the first through fourth sub-frames displayed in the right-eye period are set to the lowest value, and the luminance of each of the second and third sub-frames is set to a lower value than the luminance shown in FIG. 12. Further, in a similar manner, the entire right-eye control period is set to the transmitting period of the right-eye control section 94R.

In such a case, the image observed by the right eye via the right-eye control section 94R in the right-eye control period is the image with the luminance lower than that of the right-eye image with the luminance of 33% with respect to the maximum luminance value.

It should be noted that the same can be applied to the case of controlling the luminance of the left-eye image to be observed, and further, substantially the same luminance control can also be performed in the case of displaying a two-dimensional image.

Therefore, by controlling the luminance of the sub-frames, the luminance control of the image to be observed can more finely be performed.

Here, in the case of performing the luminance control of the sub-frames described above when displaying a three-dimensional image, it is preferable to make the luminance of the first sub-frame and the luminance of the fourth sub-frame equal to each other.

Specifically, the right-eye control period is a period set between the completion of the display of the first sub-frame and the beginning of the subsequent left-eye period. In detailed description, the beginning of the right-eye control period is set in a period from the completion of the display of the first sub-frame to the beginning of the display of the second sub-frame, and the end of the right-eye control period is set in a period from the completion of the display of the last sub-frame to the beginning of the display of the subsequent frame. Therefore, the right-eye control period includes the period for forming the second and third sub-frames. Further, in the case in which the transmitting period of the right-eye control section 94R is set to the entire period of the right-eye control period, the entire second sub-frame and the entire third sub-frame are input to the right eye of the observer through the right-eye control section 94R, and are integrated as the luminance of the right-eye image. Further, a part of the first sub-frame and a part of the fourth sub-frame are also input to the right eye, and are integrated as the luminance of the right-eye image.

Specifically, the light on the top line side in the first sub-frame is input to the right eye for a short period of time, while the light on the bottom line side is input to the right eye for a long period of time. Similarly, the light on the top line side in the fourth sub-frame is input to the right eye for a long period of time, while the light on the bottom line side is input to the right eye for a short period of time.

If the luminance proportion to the image data is the same between the first sub-frame and the fourth sub-frame, the part of the first sub-frame and the part of the fourth sub-frame to be observed act in a complementary fashion. Therefore, the right-eye image observed in the right-eye period looks substantially the same as in the case of observing one sub-frame with an even luminance proportion.

However, in the case in which the luminance proportion to the image data is different between the first sub-frame and the fourth sub-frame, the luminance proportion of the right-eye image observed by the right eye of the observer to the image data is different between a half area on the top line side and a half area on the bottom line side, which causes the luminance variation to occur.

In contrast, by making the luminance proportion to the image data equal between the first sub-frame and the fourth sub-frame, it is possible to make the luminance proportion of the right-eye image observed by the right eye of the observer in the right eye period to the image data equal between the half area on the top line side and the half area on the bottom line side. Therefore, the luminance variation can be inhibited from occurring.

It should be noted that when controlling the luminance of the sub-frame displayed in one frame period, the smaller luminance variation of each of the sub-frames is desirable. Alternately, it is desirable to set the luminance of each of the sub-frames so as to make a transition from the sub-frame with low luminance (grayscale) to the sub-frame with high luminance or a transition from the sub-frame with high luminance to the sub-frame with low luminance with time in the one frame period.

This is because the response (the performance of changing to the grayscale set) of the liquid crystal panel 321 is high in the case in which the variation in luminance between the sub-frames is small compared to the case in which the variation is large, and therefore, the image with the grayscale set can appropriately be formed and then displayed.

According to the image display system 1C related to the present embodiment explained hereinabove, in addition to the advantages substantially the same as those of the image display system 1B described above, the following advantages can be obtained.

The projector 2C is provided with the image processing section 51C as a grayscale control device for increasing or decreasing the grayscale of at least one sub-frame out of the plurality of sub-frames formed and then displayed in one frame period from the grayscale of another sub-frame.

Here, the luminance of the image to be observed is an integrated value of the luminance observed via each of the control sections 94R, 94L in one frame period. Therefore, by controlling the grayscale (luminance) of the sub-frame formed within the transmitting period of each of the control sections 94R, 94L, the luminance of the image to be observed can be controlled. Therefore, the luminance control of the observed image can more finely be performed.

Further, the timing control section 52 sets the start timing of the transmitting period of the corresponding control section in a period from the completion of the display of the first sub-frame to the beginning of the display of the second sub-frame in one frame period, and sets the end timing of the transmitting period in a period from the completion of the display of the last sub-frame to when the subsequent one frame period is started. Further, the image processing section 51C as the grayscale control device makes the luminance of the first sub-frame and the luminance of the last sub-frame equal to each other.

According to this configuration, when displaying a three-dimensional image, the luminance variation in the right-eye image to be observed by the right eye via the right-eye control section 94R and the luminance variation in the left-eye image to be observed by the left eye via the left-eye control section 94L can be inhibited from occurring.

### Modifications of Embodiments

The invention is not limited to the embodiments described above, but includes modifications and improvements in a range where the advantages of the invention can be achieved.

In each of the embodiments described above, the display control section 53 drives the liquid crystal panel 321 at the frequency, which is an integral multiple equal to or greater than twice of the signal frequency of the image signal received to thereby form a plurality of sub-frames in one frame period. However, besides this configuration, it is possible to form one sub-frame in one frame period, and control the transmitting period of each of the right-eye control section 91R, 94R and the left-eye control section 91L, 94L.

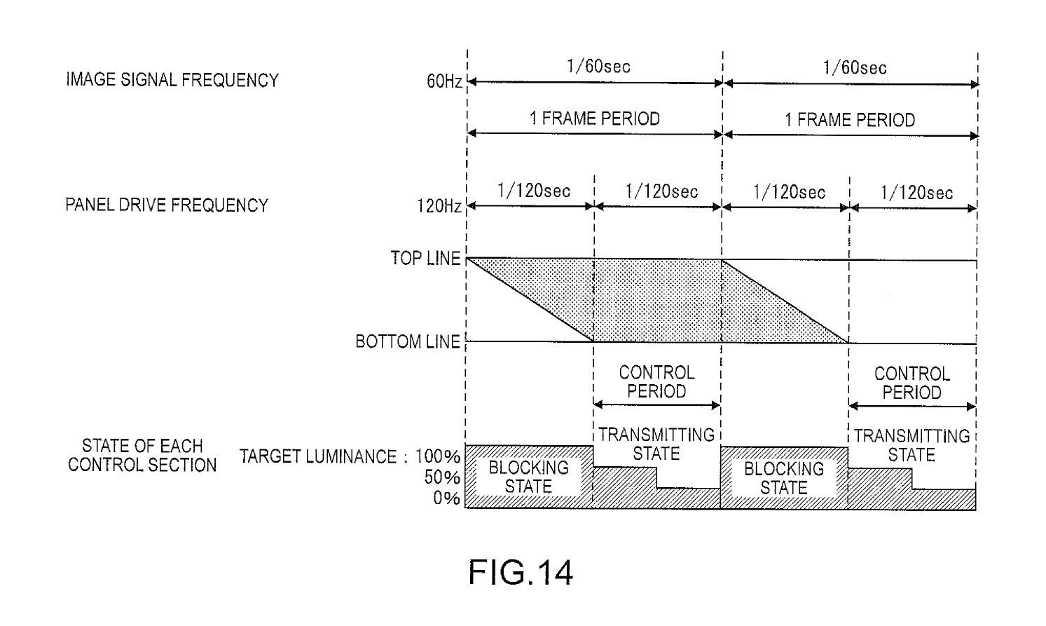

FIG. 14 is a diagram showing another example of the luminance control using the right-eye control section 91R and the left-eye control section 91L when displaying a two-dimensional image. In other words, FIG. 14 is a diagram showing an example of the relationship between the image forming period by the liquid crystal panel 321 and the states of each of the control sections 91R, 91L.

Specifically, in the case of driving the liquid crystal panel 321 at 120 Hz, which is twice as high as the signal frequency, with respect to the image signal of 60 Hz, the first sub-frame and the second sub-frame are sequentially formed in the image display system 1A described above.

In contrast, as shown in FIG. 14, it is also possible to keep the first sub-frame without forming the second sub-frame after forming the first sub-frame.

Even in such a case, by controlling the transmitting period of each of the control sections 91R, 91L in one frame period, substantially the same advantages as those of the image display system 1A described above can be obtained.

It should be noted that even in the case of adopting the control sections 94R, 94L as the right-eye control section and the left-eye control section, respectively, substantially the same advantages can be obtained. Further, in the case of displaying a three-dimensional image, by setting the corresponding control section to the transmitting state after the completion of the display of the first sub-frame described above, substantially the same advantages as described above can be obtained.

Although in each of the embodiments described above, it is assumed that the projector 2A through 2C displays the right-eye image and the left-eye image as the parallax images corresponding to the first image and the second image, the invention is not limited thereto. Specifically, it is also possible to alternately display the first image and the second image irrelevant to each other. In this case, by setting each of the control sections of the pair of glasses 9A, 9B to be worn by the observer who observes the first image to the transmitting state in one frame period of the first image, and then setting the control sections thereof to the blocking state in one frame period of the second image, the observer can observe only the first image. Similarly, by setting each of the control sections of the pair of glasses 9A, 9B to be worn by the observer who observes the second image to the transmitting state in one frame period of the second image, and then setting the control sections thereof to the blocking state in one frame period of the first image, the observer can observe only the second image.

Although in each of the embodiments described above, the voltage to the top line is applied after applying the voltage to the bottom line without an interval, the invention is not limited thereto. Specifically, it is possible to apply the voltage to the top line after applying the voltage to the bottom line with an interval.

In each of the embodiments described above, it is assumed that the start timing of the right-eye control period and the left-eye control period is set to the completion of the display of the first sub-frame. However, besides the above, the start timing can be set in a period from the completion of the display of the first sub-frame to the beginning of the subsequent one frame period. Further, the end timing of the control period can also be set in a period from the completion of the display of the last sub-frame to the beginning of the subsequent one frame period.

In other words, the start timing and the end timing of the transmitting period of each of the control sections 91R, 91L, 94R, and 94L can be set arbitrarily. The same applies to the case of displaying a two-dimensional image.

The transmitting period of each of the control sections 91R, 91L in one frame period is controlled in the first embodiment described above, and the light transmittance of each of the control sections 94R, 94L is controlled in addition to controlling the transmitting period thereof in the second embodiment described above. Further, in the third embodiment described above, the control of the transmitting period and the luminance control of the sub-frames are performed. However, the invention is not limited thereto. Specifically, each of the control of the transmitting period, the control of the light transmittance, and the luminance control of the sub-frames can be performed.

Although in each of the embodiments, it is assumed that the timing control section 52 as the transmitting period control device provided to the projector 2A through 2C controls the transmitting period of each of the control sections 91R, 91L, 94R, and 94L, the invention is not limited thereto. Specifically, there can be adopted a configuration in which the transmitting period control device for controlling the transmitting period is provided to the pair of glasses 9A, 9B. In this case, it is possible for the transmitting period control device to set the transmitting period in accordance with the operation and so on of the observer to the operation section 95. Further, for example, the drive control section of the pair of glasses can switch the corresponding control section to the transmitting state based on the switching signal for indicating the switching to the transmitting state, and then switch the control section to the blocking state after the termination of the transmitting period.

Although in each of the embodiments, the period (the period in which the image data corresponding to one frame is input) of the image signal input and the image forming period by the liquid crystal panel 321 are shown in sync with each other, the invention is not limited thereto as described above. In other words, these periods can be shifted from each other.

In each of the embodiments, the light modulation section 32 has the configuration having the liquid crystal panel 321 driven by the display control section 53 using the line sequential method. However, besides this configuration, a configuration having the light modulation device other than liquid crystal, such as a device using micromirrors can be adopted. Even in the device with a relatively high writing speed, there exists a problem of, for example, the reaction speed (the response of the state switching) of each of the control sections 91R, 91L, 94R, and 94L each formed of the liquid crystal shutter. Therefore, by setting the period from the completion of the writing before the writing of the subsequent image to the control period, the effect of reducing the mixture between the right-eye image and the left-eye image can be expected.

Although in each of the embodiments, the projector 2A through 2C for projecting the image on the projection surface of the screen Sc to thereby display the image is cited as the display device, the invention is not limited thereto. Specifically, a variety of types of displays such as a liquid crystal display, a plasma display, and an organic electro-luminescence (EL) display can be adopted as the display device.

Although in each of the embodiments, the case in which the number of scan lines (the scan lines to be selected) for writing the data at a time is one is explained, the number of scan lines is not limited to one. In the case of providing a plurality of memories for storing the voltage corresponding to the grayscale of the image as many as a plurality of scan lines, it is possible to write the data at a time with the plurality of scan lines. For example, by providing the memories corresponding to the two scan lines, dividing the screen into an upper half and a lower half, and then writing the data with the two scan lines at the same time, the writing time is halved, and it becomes easy to increase the update frequency of the image. The case in which the plurality of scan lines are provided is substantially the same as the case of providing one scan line in the point that there exist the line (the top line described above) to be written first in one sub-frame and the line (the bottom line described above) to be written last.

The invention can be applied to an image display system provided with a display device for displaying an image and a pair of glasses such as an image display system for displaying a two-dimensional image, an image display system for alternately displaying a right-eye image and a left-eye image, and an image display system for alternately displaying a first image and a second image irrelevant to each other.

The entire disclosure of Japanese Patent Application No. 2012-159825, filed Jul. 18, 2012 is expressly incorporated by reference herein.

What is claimed is:

1. An image display system comprising:
a display device adapted to display an image; and
a pair of glasses having a transmitting state switching device capable of switching between a transmitting state in which a light adapted to form the image is transmitted and a blocking state in which the light is blocked,
wherein one of the display device and the pair of glasses includes a transmitting period control device adapted to control a length of a transmitting period in which the transmitting state switching device is in the transmitting state in a display period in which the image of one frame is displayed in the display device.

2. The image display system according to claim 1, wherein
a plurality of sub-frames corresponding to the image is sequentially displayed in the display period of the image of the one frame, and
the transmitting period control device sets a start timing of the transmitting period to a point on and after a time point at which display of first one of the sub-frames is completed in the display period.

3. The image display system according to claim 2, wherein
the display device includes a grayscale control device adapted to one of increase and decrease a grayscale of at least one of the sub-frames from a grayscale of another of the sub-frames.

4. The image display system according to claim 3, wherein
the transmitting period control device sets
a start timing of the transmitting period between a time point at which display of the first one of the sub-frames is completed in the display period and a time point at which display of a second one of the sub-frames is started, and
an end timing of the transmitting period between a time point at which display of a last one of the sub-frames is completed and a time point at which display of a first one of a plurality of sub-frames constituting a subsequent frame is started, and
the grayscale control device makes the gray scale of the first one of the sub-frames and the grayscale of the last one of the sub-frames equal to each other.

5. The image display system according to claim 1, wherein
the transmitting period control device controls a length of the transmitting period frame by frame.

6. The image display system according to claim 1, wherein
the transmitting state switching device is configured to be able to control a light transmittance of the transmitting state switching device, and
the pair of glasses include a transmittance control device adapted to control the light transmittance of the transmitting state switching device.

7. The image display system according to claim 1, wherein
the pair of glasses include a liquid crystal shutter as the transmitting state switching device.

8. A luminance control method performed using an image display system having a display device adapted to display an image, and a pair of glasses configured to be able to switch between a transmitting state in which a light adapted to form the image is transmitted and a blocking state in which the light is blocked, and adapted to control luminance of the image transmitted through the pair of glasses, the method comprising:
controlling a length of a transmitting period, in which a transmitting state switching device provided to the pair of glasses and capable of switching between the transmitting state of transmitting the light forming the image and the blocking state of blocking the light is in the transmitting state, in a display period in which the image of one frame is displayed in the display device.
